(19) United States
(12) Patent Application Publication
(10) Pub. No.: US 2020/0380745 A1
(43) Pub. Date: Dec. 3, 2020

(54) METHODS AND APPARATUS FOR VIEWPOINT VISIBILITY MANAGEMENT

(71) Applicant: QUALCOMM Incorporated, San Diego, CA (US)

(72) Inventors: Kalyan Kumar BHIRAVABHATLA, Bengaluru (IN); Viswanath Shashikant NIKAM, Bangalore (IN); Suvam CHATTERJEE, Kolkata (IN); Nagarjuna DUVVURU, Bangalore (IN)

(21) Appl. No.: 16/427,202

(22) Filed: May 30, 2019

(51) Int. Cl. G06T 11/60; G06T 1/20; G06T 1/60; G06T 7/70

(52) U.S. Cl. CPC G06T 11/60; G06T 7/70; G06T 1/60; G06T 1/20

(57) ABSTRACT

The present disclosure relates to methods and apparatus for graphics processing. The apparatus can determine visibility information for each of a plurality of primitives in a first viewpoint or any available viewpoint of an image. In some aspects, the visibility information can include information regarding whether the primitive is visible in the first viewpoint. The apparatus can also determine a visibility stream based on the determined visibility information for each of the plurality of primitives in the first viewpoint. Additionally, the apparatus can identify at least one of the plurality of primitives in the first viewpoint as not visible based on the determined visibility information. The apparatus can also determine to skip rendering the plurality of primitives in the first viewpoint identified as not visible. Further, the apparatus can send and store the visibility stream in the buffer and retrieve the visibility stream from the buffer.

### TECHNICAL FIELD

The present disclosure relates generally to processing systems and, more particularly, to one or more techniques for graphics processing.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform the processes in a graphics processing pipeline. However, with the advent of wireless communication and smaller, handheld devices, there has developed an increased need for improved graphics processing.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU). In some aspects, the apparatus can determine visibility information for each of a plurality of primitives in a first viewpoint of an image or any available viewpoint of the image. The visibility information can include information regarding whether the primitive is visible in the first viewpoint. The apparatus can also determine a visibility stream based on the determined visibility information for each of the plurality of primitives in the first viewpoint. Additionally, the apparatus can identify at least one of the plurality of primitives in the first viewpoint as not visible based on the determined visibility information. The apparatus can also determine to skip rendering the plurality of primitives in the first viewpoint identified as not visible.

In some aspects, the apparatus can also determine visibility information for each of a plurality of primitives in at least one additional viewpoint of the image or any of the available viewpoints of the image. The apparatus can also adjust the visibility stream to include the determined visibility information for each of the plurality of primitives in the at least one additional viewpoint. Also, the apparatus can identify at least one of the plurality of primitives in the at least one additional viewpoint as not visible based on the determined visibility information. The apparatus can also determine to skip rendering the at least one of the plurality of primitives in the at least one additional viewpoint identified as not visible. Further, the apparatus can send the visibility stream to a buffer and/or store the visibility stream in the buffer. The apparatus can also retrieve the visibility stream from the buffer when the visibility stream is stored in the buffer.

The apparatus can also identify one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint. Further, the apparatus can render the one or more of the plurality of primitives in the first viewpoint and the plurality of primitives in the at least one additional viewpoint identified as visible. The apparatus can also generate the visibility stream based on the determined visibility information for each of the plurality of primitives in the first viewpoint and the determined visibility information for each of the plurality of primitives in the at least one additional viewpoint. Moreover, the apparatus can determine the plurality of primitives in the first viewpoint and the plurality of primitives in the at least one additional viewpoint. The apparatus can also generate graphical content based on the determined visibility information for each of the plurality of primitives in the first viewpoint and generate graphical content based on the determined visibility information for each of the plurality of primitives in the at least one additional viewpoint.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example GPU in accordance with one or more techniques of this disclosure.

FIGS. 3A and 3B illustrate example images or surfaces in accordance with one or more techniques of this disclosure.

FIGS. 4A and 4B illustrate example flowcharts of a visibility and rendering process, respectively, in accordance with one or more techniques of this disclosure.

FIG. 5 illustrates an example flowchart of visibility and geometry processing in accordance with one or more techniques of this disclosure.

FIGS. 6A and 6B illustrate example flowcharts of a visibility and rendering process, respectively, in accordance with one or more techniques of this disclosure.

FIG. 7 illustrates an example image or surface in accordance with one or more techniques of this disclosure.

FIG. 8 illustrates an example flowchart of an example method in accordance with one or more techniques of this disclosure.

### DETAILED DESCRIPTION

Aspects of the present disclosure can avoid unnecessary geometry processing, e.g., vertex processing and/or primitive processing, of primitives that are determined to be not visible. For instance, aspects of the present disclosure can avoid rendering replicated primitives in rendering pass by including visibility information on a per-view basis in a primitive visibility stream. GPUs herein can also identify and/or mark primitives as visible or not visible on a per-view basis. By doing so, when aspects of the present disclosure perform the geometry processing for primitives and/or render the primitives, only visible primitives will be processed and/or rendered. As such, aspects of the present disclosure can save or conserve rendering or processing resources by rendering or processing the primitives that are visible.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

As used herein, instances of the term “content” may refer to graphical content or display content. In some examples, as used herein, the term “graphical content” may refer to a content generated by a processing unit configured to perform graphics processing. For example, the term “graphical content” may refer to content generated by one or more processes of a graphics processing pipeline. In some examples, as used herein, the term “graphical content” may refer to content generated by a graphics processing unit. In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

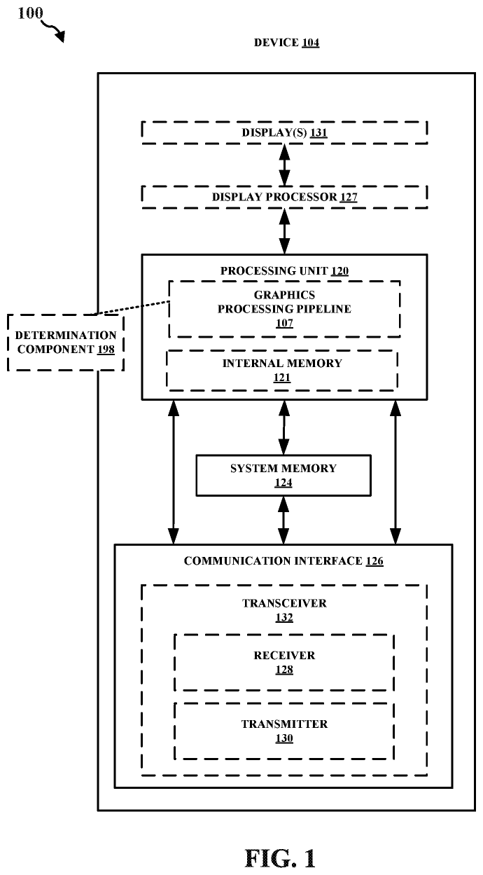

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120, such as system memory 124, may be accessible to the processing unit 120. For example, the processing unit 120 may be configured to read from and/or write to external memory, such as the system memory 124. The processing unit 120 may be communicatively coupled to the system memory 124 over a bus. In some examples, the processing unit 120 may be communicatively coupled to each other over the bus or a different connection.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the graphics processing pipeline 107 may include a determination component 198 configured to determine visibility information for each of a plurality of primitives in a first viewpoint of an image or any available viewpoint of the image. The visibility information can include information regarding whether the primitive is visible in the first viewpoint. The determination component 198 can also be configured to determine a visibility stream based on the determined visibility information for each of the plurality of primitives in the first viewpoint. Additionally, the determination component 198 can be configured to identify at least one of the plurality of primitives in the first viewpoint as not visible based on the determined visibility information. The determination component 198 can also be configured to determine to skip rendering the plurality of primitives in the first viewpoint identified as not visible.

In some aspects, the determination component 198 can also be configured to determine visibility information for each of a plurality of primitives in at least one additional viewpoint of the image or any of the available viewpoints of the image. The determination component 198 can also be configured to adjust the visibility stream to include the determined visibility information for each of the plurality of primitives in the at least one additional viewpoint. Also, the determination component 198 can be configured to identify at least one of the plurality of primitives in the at least one additional viewpoint as not visible based on the determined visibility information. The determination component 198 can also be configured to determine to skip rendering the at least one of the plurality of primitives in the at least one additional viewpoint identified as not visible. Further, the determination component 198 can be configured to send the visibility stream to a buffer, and be configured to store the visibility stream in the buffer. The determination component 198 can also be configured to retrieve the visibility stream from the buffer when the visibility stream is stored in the buffer.

The determination component 198 can also be configured to identify one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint. Further, the determination component 198 can be configured to render the one or more of the plurality of primitives in the first viewpoint and the plurality of primitives in the at least one additional viewpoint identified as visible. The determination component 198 can also be configured to generate the visibility stream based on the determined visibility information for each of the plurality of primitives in the first viewpoint and the determined visibility information for each of the plurality of primitives in the at least one additional viewpoint. Moreover, the determination component 198 can be configured to determine the plurality of primitives in the first viewpoint and the plurality of primitives in the at least one additional viewpoint. The determination component 198 can also be configured to generate graphical content based on the determined visibility information for each of the plurality of primitives in the first viewpoint and generate graphical content based on the determined visibility information for each of the plurality of primitives in the at least one additional viewpoint.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein.

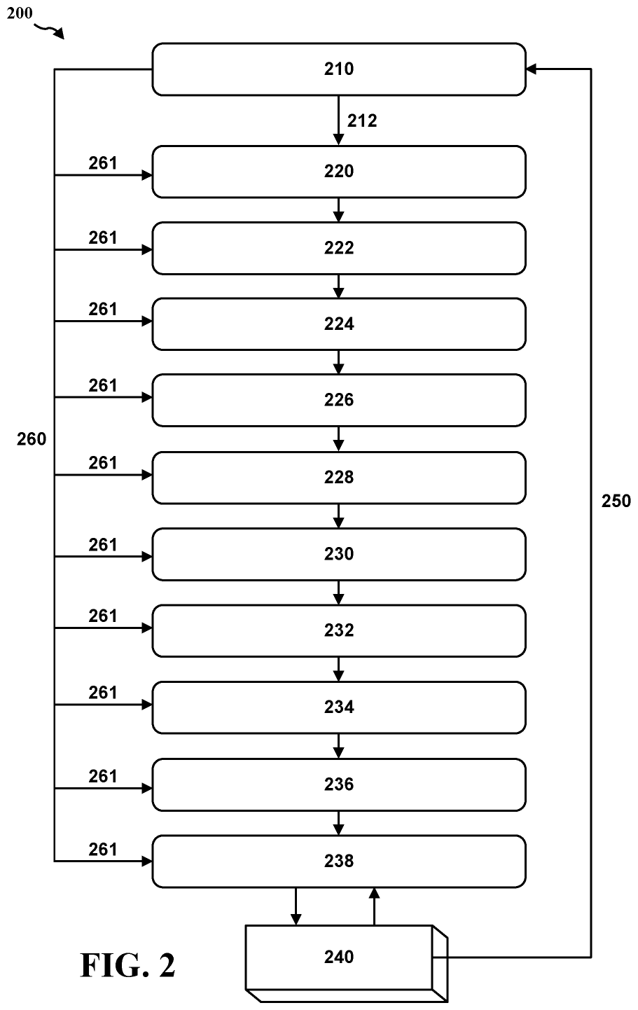

FIG. 2 illustrates an example GPU 200 in accordance with one or more techniques of this disclosure. As shown in FIG. 2, GPU 200 includes command processor (CP) 210, draw call packets 212, vertex fetcher (VFD) 220, vertex shader (VS) 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

GPUs herein can process multiple types of data in a GPU pipeline. For instance, in some aspects, a GPU can process two types of data or data packets, e.g., context register packets and draw call data. As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can be structured as follows: context register of context N, draw call(s) of context N, context register of context N+1, and draw call(s) of context N+1.

GPUs can render images in a variety of different ways. In some instances, GPUs can render an image using rendering or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. Moreover, in the binning pass, different primitives can be shaded in certain bins, e.g., using draw calls. In some aspects, during the binning pass, a visibility stream can be constructed where visible primitives or draw calls can be identified.

In some aspects, GPUs can apply the drawing or rendering process to different bins or tiles. For instance, a GPU can render to one bin, and then perform all the draws for the primitives or pixels in the bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a primitive visibility stream can be generated, e.g., in a binning pass, to determine the visibility information of each primitive in an image or scene. For instance, this primitive visibility stream can identify whether a certain primitive is visible or not. In some aspects, this information can be used to remove primitives that are not visible, e.g., in the rendering pass. Also, at least some of the primitives that are identified as visible can be rendered in the rendering pass.

Some types of GPUs or GPU architecture can support different types of tiled rendering, e.g., tile based deferred rendering (TBDR). TBDR can refer to rendering primitives or triangles one screen or bin at a time. As such, rendering can be performed on a bin-by-bin basis, until all the primitives or triangles have been rendered. In some aspects, GPUs operating TBDR can select a specific bin or area of an image, e.g., a rectangle, and render all of the primitives or triangles that fall into that bin or area. In some aspects of TBDR rendering, the potential rendering area can be divided in smaller tiles called bins such that certain data, e.g., depth and color data, can be present in on-chip graphics memory (GMEM). The rendering can then be performed one bin followed by next. In turn, this can reduce memory bandwidth.

In some aspects of tiled rendering or TBDR, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitives in each bin or area, e.g., in a system memory. This visibility information can be used to determine or generate a primitive visibility stream. In a rendering pass, the primitives in each bin can be rendered separately. In these instances, the primitive visibility stream can be fetched from memory used to drop primitives which are not visible for that bin.

Some GPUs or GPU architectures may process or render the primitives of the same geometry for multiple viewpoints or views in an image. For instance, the same set of primitives can be processed or rendered according to multiple viewpoints within an image. This type of rendering can be referred to as multiple view or multi-view rendering. Some examples of multiple view or multi-view rendering are stereo rendering for virtual reality (VR), cube map rendering, and/or cascaded shadow mapping rendering. In some instances of multiple view or multi-view rendering, GPUs can process new workloads or use cases in multiple views. For these use cases, GPUs can render similar data or primitives in multiple views. For example, in VR rendering, GPUs may have to render a left side view separately from a right side view. For instance, as there are minor differences between these different views, the views may need to be rendered separately, even though to the naked eye these views look the same.

Some aspects of GPUs or GPU architecture can provide a number of different options for multi-view rendering, e.g., software multi-view rendering and hardware multi-view rendering. In software multi-view rendering, a driver can replicate an entire frame geometry by processing each view one time. Additionally, some different states, e.g., a viewport or render target index, may be changed depending on the view. As such, in software multi-view rendering, the software can replicate the entire workload by changing some states that may be required to render for each viewpoint in an image. In certain aspects, as GPUs may be submitting the same workload multiple times for each viewpoint in an image, there may be an increased amount of overhead.

In hardware multi-view rendering, the hardware may be responsible for replicating or processing the geometry for each viewpoint in an image. Accordingly, the hardware can manage the replication or processing of the primitives or triangles for each viewpoint in an image. In some instances, both software multi-view rendering and hardware multi-view rendering may utilize tiled rendering mode or TBDR. Additionally, in some aspects, hardware multi-view rendering may avoid sequential processing of each viewpoint in an image. By doing so, hardware multi-view rendering may provide accelerated processing and/or reduced overhead compared to software multi-view rendering. However, the overall performance of hardware multi-view rendering may still be less than or equal to the performance of software multi-view rendering. Some aspects of the present disclosure may improve the performance of hardware multi-view rendering.

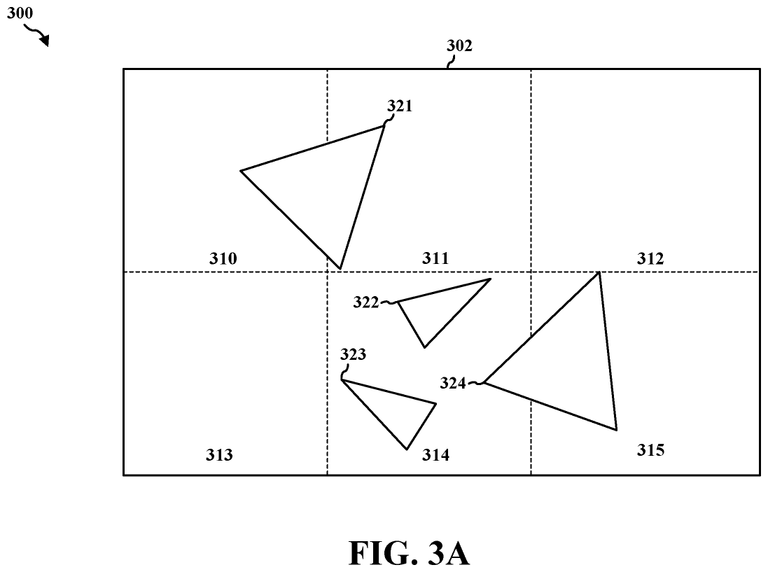

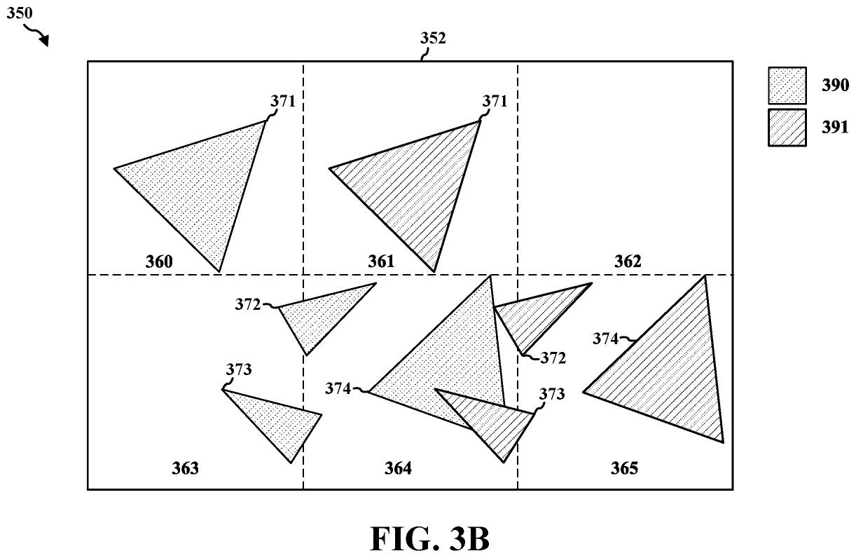

FIGS. 3A and 3B illustrate images or surfaces 300 and 350, respectively, including multiple primitives divided into multiple bins. As shown in FIG. 3A, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3A illustrates an example of tiled rendering using a single viewpoint for the primitives 321-324. Accordingly, the GPU processing or rendering the image or surface 300 including area 302 does not utilize multi-view rendering.

As shown in FIG. 3B, image or surface 350 includes area 352, which includes primitives 371, 372, 373, and 374. The primitives 371-374 are divided or placed into different bins, e.g., bins 360, 361, 362, 363, 364, and 365. FIG. 3B illustrates an example of tiled rendering using multiple viewpoints for the primitives 371-374. For instance, primitives 371-374 are in first viewpoint 390 and second viewpoint 391. As such, the GPU processing or rendering the image or surface 350 including area 352 can utilize multiple viewpoints or multi-view rendering.

FIG. 3B shows one example of how primitives or triangles, e.g., primitives 371-374, are divided into different bins in a multiple viewpoint scenario. For instance, primitive 371 in viewpoint 390 is replicated as primitive 371 in viewpoint 391. As primitive 371 is replicated, it can end up in different bins, e.g., bins 360 and bin 361, respectively. Accordingly, primitives or triangles can fall into two different bins in different viewpoints. In some aspects, a primitive or triangle may be marked as visible for one bin, and then have the geometry processed for both bins. This can occur even if the primitive is only visible for one bin. For example, primitive 371 in bin 360 may be visible in viewpoint 390, while primitive 371 in bin 361 may not be visible in viewpoint 391.

As mentioned above, FIG. 3B displays a diagrammatic representation of image or surface 350 when utilizing multiple viewpoint rendering with two different views. For example, FIG. 3B may be a VR usage model, where the dotted lines indicate the bin boundaries. FIG. 3B may also represent hardware multi-view rendering, where the hardware can internally replicate geometry for each view represented by the primitives or triangles in different viewpoints, e.g., primitives 371-374 in viewpoint 390 and viewpoint 391. In some aspects, during hardware multi-view rendering, GPUs can identify or mark a particular primitive or triangle as visible if it is visible in any viewpoint. In further aspects, primitive visibility information can be recorded based on one primitive if the primitive is considered visible in any viewpoint for any bin.

TABLE 1

| | | | | | |
|---|---|---|---|---|---|
| Bin 360 | Bin 361 | Bin 362 | Bin 363 | Bin 364 | Bin 365 |

Visibility stream

| | | | | | |
|---|---|---|---|---|---|
| Vis 371 | Vis 371 | Inv 371-374 | Inv 371 | Inv 371 | Inv 371 |
| Inv 372-374 | Inv 372-374 | | Vis 372-373 | Vis 372-374 | Vis 372-374 |
| | | | Inv 374 | | |

Bin Render Geometry Processing

| | | | | |
|---|---|---|---|---|
| 371 v390 | 371 v390 | 372 v390 | 372 v390 | 372 v390 |
| 371 v391 | 371 v391 | 372 v391 | 372 v391 | 372 v391 |
| | | 373 v390 | 373 v390 | 373 v390 |
| | | 373 v391 | 373 v391 | 373 v391 |
| | | | 374 v390 | 374 v390 |
| | | | 374 v391 | 374 v391 |

Total Number of Primitives Geometry Processed for each Bin

| | | | | | |
|---|---|---|---|---|---|
| 2 | 2 | 0 | 4 | 6 | 6 |

Table 1 shows the visibility stream for primitives 371-374 in FIG. 3B. Table 1 also displays the existing geometry processing scheme for FIG. 3B. For example, in bin 360, primitive 371 is visible, which is indicated by “Vis 371” in bin 360 in Table 1. Primitives 372-374 are invisible in bin 360, so they are indicated as “Inv 372-374” in bin 360 in Table 1. Accordingly, in the bin-rendering pass of bin 360, only primitive 371 is processed. As shown in Table 1, primitive 371 is geometry processed for both viewpoint 390 and 391. Indeed, as viewpoint information may not be stored in the visibility stream, both the viewpoints of primitive 371 are geometry processed, with viewpoint 391 of primitive 371 getting dropped later in the GPU pipeline. Therefore, in some aspects, certain viewpoints of primitives may be geometry processed even though they are not visible and the rendering process will be dropped later in the GPU pipeline.

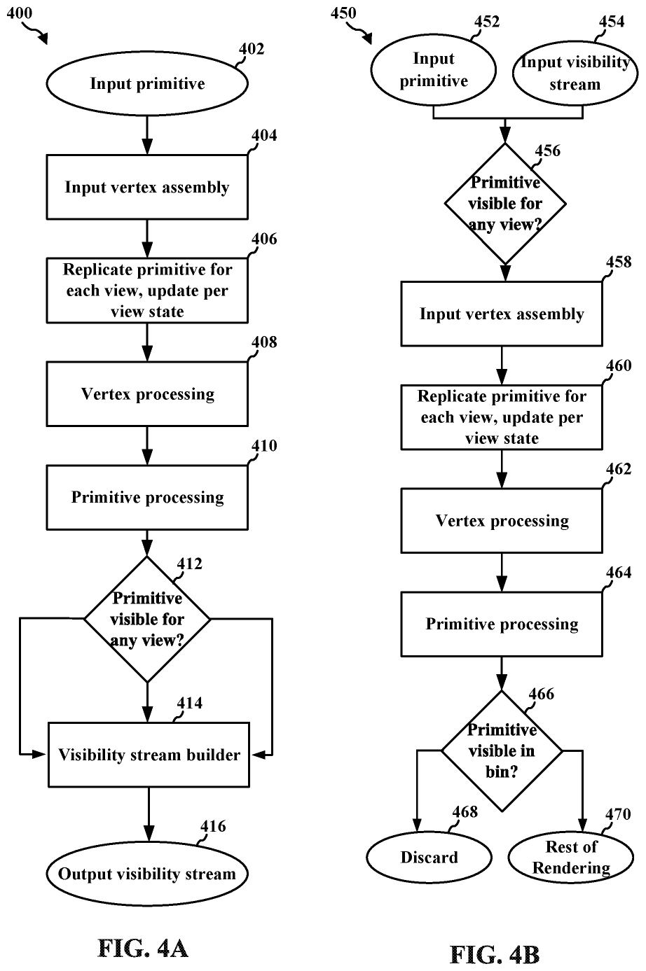

FIGS. 4A and 4B illustrate example flowcharts 400 and 450, respectively. As shown in FIG. 4A, flowchart 400 represents a visibility or bin-visibility process or pass of a GPU. At 402, the GPU can input primitives. At 404, the GPU can input the vertex assembly. For instance, after the GPU inputs a primitive during the visibility pass, the GPU can perform a vertex assembly. At 406, the GPU can replicate the primitives for each view, and update a per-view or viewpoint state. Next, at 408, the GPU can perform vertex processing. During the vertex processing, the primitives can be processed on a per-view basis. At 410, the GPU can perform primitive processing. At 412, the GPU can determine whether a primitive is visible for any view. If a primitive is visible for any view, at 414, the GPU can build or process a visibility stream. Finally, at 416, the GPU can output the visibility stream.

As shown in FIG. 4B, flowchart 450 represents a rendering or bin-rendering process or pass of a GPU. At 452, the GPU can input primitives. At 454, the GPU can input the visibility stream. At 456, the GPU can determine whether a primitive is visible for any view. At 458, the GPU can input a vertex assembly. Next, at 460, the GPU can replicate or duplicate the primitives for each view, and update a per-view or viewpoint state. At 462, the GPU can perform vertex processing. During the vertex processing, the primitives can be processed on a per-view basis. At 464, the GPU can perform primitive processing. At 466, the GPU can determine whether a primitive is visible in any bin. If a primitive is visible in any bin, at 470, the GPU can perform the rest of the rendering process. Otherwise, at 468, the GPU can discard the primitive.

As mentioned above, primitive or triangles can be translated or replicated for each view and may end up falling into different bins. In some aspects of multi-view rendering, a significant percentage of the primitives or triangles may be visible in one bin but not another, i.e., disjoint visibility, for each view. Also, for different workloads in multi-view rendering, there may be a horizontal and/or vertical offset when performing certain types of multi-view rendering, e.g., for VR. For other use cases, the horizontal and/or vertical offsets may be completely random. In these cases, the primitives or triangles that fall into one bin in one view may not fall into the same bin in another view.

In some instances, GPUs may mark a primitive or triangle as visible, even if it is not visible in another view or bin. However, in some aspects, in the rendering pass, all primitives marked as visible may be replicated again and geometry processed. Replicated primitives that are not visible for that bin may be dropped at a later stage in the GPU pipeline. Accordingly, GPUs may render the same primitives or triangles in the rendering pass or phase, even when it is unnecessary to do so. Thus, these replicated primitives can waste processing cycles for performing unnecessary or unwanted vertex processing.

Aspects of the present disclosure can avoid unnecessary geometry processing, e.g., vertex processing and primitive processing, of invisible replicated primitives. For instance, GPUs herein can avoid processing primitives that are not visible in the rendering pass by adding per-view or viewpoint specific visibility information in the primitive visibility stream. Aspects of the present disclosure can include a visibility algorithm that adds a visibility stream with per-view visibility information, which can identify or mark the primitives or triangles as visible on a per-view and/or per-bin basis. By doing so, when GPUs herein perform the bin rendering pass, GPUs may only render primitives or triangles that are actually visible. As such, aspects of the present disclosure can avoid unnecessarily rendering invisible primitives, and prevent wasting processing cycles for performing unnecessary geometry processing. In order to do so, aspects of the present disclosure can identify or mark primitives on a per-view and/or per-bin basis. Additionally, some primitives from multiple views can be placed in different bins.

In some aspects of the present disclosure, when performing the bin visibility pass, GPUs herein may replicate each of the triangles for each view. By doing so, each primitive or triangle may receive a new position, e.g., where the triangle is located within the view, when it is replicated. In some instances, when a primitive is processed down the GPU pipeline, GPUs herein can determine whether the primitive is visible. Aspects of the present disclosure may identify or mark a particular primitive as visible based on the per-view basis, i.e., based on a particular viewpoint, and/or the corresponding bin and based on the position of the primitive. Accordingly, in some aspects, GPUs herein can analyze each pixel in the primitive and compare the pixels with the bin, and then identify or mark the pixels if they are visible in a bin. In some aspects, this can occur for each of the primitives or triangles in all the viewpoints.

As indicated above, aspects of the present disclosure can add per-view visibility information by identifying or marking the visibility of each primitive in each separate viewpoint. In some aspects, this can occur in the visibility recording step in the bin visibility pass. Also, in the bin rendering pass, when there is potentially unnecessary geometry processing, GPUs herein can use this information and only process the geometry for visible primitives. Accordingly, aspects of the present disclosure can avoid unnecessary geometry processing or rendering primitives that are not visible. In some instances, aspects of the present disclosure can identify or mark the primitives on a per-view basis and/or per-bin basis. By doing so, GPUs herein can avoid the geometry processing of invisible primitives for a particular view. Indeed, aspects of the present disclosure may not process the geometry of a primitive if it is not visible for a certain viewpoint.

As mentioned herein, when the geometry is processed for a certain primitive, it can result in multiple primitives for multiple views. As a result, the primitives or triangles are processed separately for each viewpoint of an image. For example, the hardware can determine which primitive or triangle corresponds to which viewpoint. Aspects of the present disclosure can determine a visibility information for each primitive on a per-view basis. In some instances, GPUs herein can determine the primitive visibility on the per-view basis based on the information from the hardware after processing each primitive separately for each viewpoint. Aspects of the present disclosure can identify and/or determine each primitive or each pixel of the primitive, and if any of the pixels are determined as visible, they can be marked. As each pixel is analyzed or scanned, GPUs herein can determine which pixels are visible in each bin. Then the pixels can be marked or identified as visible in a certain bin. Accordingly, aspects of the present disclosure can mark and record the primitive visibility on a per-view basis. GPUs herein can also determine invisible primitives on a per-view basis. By doing so, aspects of the present disclosure can skip the geometry processing of invisible primitives for certain viewpoints.

Aspects of the present disclosure can also include a buffer or visibility buffer. In some aspects, this can be a buffer in the memory or memory resources where per-view data can be stored. As this buffer can be used to store per-view data, it can allocate more space to GPUs herein. In some aspects, this buffer can be used in the bin-rendering pass. With per-view visibility, the memory requirements of the buffer may increase, such that GPUs herein may require a larger portion of memory to store the visibility data. In some aspects, visibility information or a visibility stream for certain viewpoints can be sent to the buffer, stored in the buffer, and/or retrieved from the buffer, e.g., to be used during geometry processing or rendering. In some aspects, the visibility stream can be fetched for every bin, e.g., during bin-rendering. Moreover, based on a per-view visibility of each primitive, invisible views of the primitive can be dropped from the visibility stream.

As mentioned herein, aspects of the present disclosure can determine visibility information and/or a visibility stream based on the visibility of certain viewpoints. This visibility information can then be stored in a visibility buffer. In some aspects, if GPUs herein require this visibility information, the information can be sent to another component in the GPU pipeline, e.g., an input assembler. By doing so, aspects of the present disclosure can avoid the unnecessary geometry processing or rendering of invisible primitives, e.g., on a per-view basis.

TABLE 2

| | | | | | |
|---|---|---|---|---|---|
| Bin 360 | Bin 361 | Bin 362 | Bin 363 | Bin 364 | Bin 365 |

Visibility stream

| | | | | | |
|---|---|---|---|---|---|
| Vis 371 | Vis 371 | Inv 371-374 | Inv 371 | Inv 371 | Inv 371 |
| (v390) | (v391) | | | | |
| Inv 372-374 | Inv 372-374 | | Vis 372-373 | Vis 373-374 | Vis 372-374 |
| | | | (v390) | (v390) | (v391) |
| | | | Inv 374 | Vis 373 | |
| | | | | (v391) | |
| | | | | Vis 374 | |
| | | | | (v390) | |

Bin Render Geometry Processing

| | | | | |
|---|---|---|---|---|
| 371 v390 | 371 v391 | 372 v390 | 372 v390 | 372 v391 |
| | | 373 v390 | 373 v390 | 373 v391 |
| | | | 373 v391 | 374 v391 |
| | | | 374 v390 | |

Total Number of Primitives Geometry Processed for each Bin

| | | | | | |
|---|---|---|---|---|---|
| 1 | 1 | 0 | 2 | 4 | 3 |

Table 2 shows the visibility stream for primitives 371-374 in FIG. 3B based on the per-view visibility information according to the present disclosure. Table 2 also displays the existing geometry processing scheme for FIG. 3B based on the per-view visibility information according to the present disclosure. Table 2 shows that aspects of the present disclosure can save significant geometry processing by utilizing the per-view visibility information. Accordingly, aspects of the present disclosure can save on unnecessary geometry processing or rendering of invisible primitives in certain viewpoints. Table 2 also shows that aspects of the present disclosure can store visibility information on a per-view basis in the visibility stream and use it in the bin-rendering pass. For example, in bin 360 of FIG. 3B, as only one view of primitive 371 is visible, e.g., in viewpoint 390, then during bin-rendering pass of bin 360, only the visible viewpoint, e.g., viewpoint 390, of primitive 371 is geometry processed. Hence, aspects of the present disclosure can skip the geometry processing of invisible primitives in certain viewpoints.

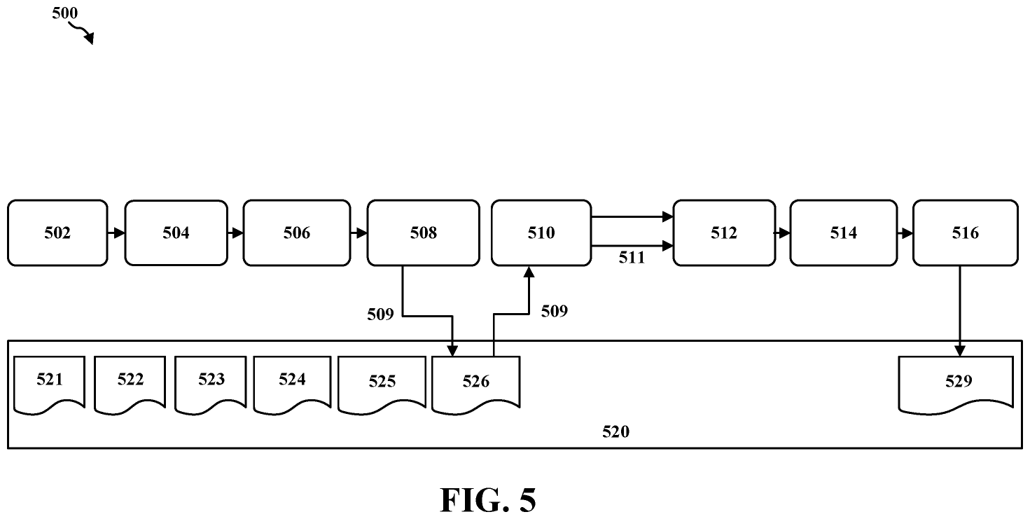

FIG. 5 illustrates an example flowchart 500 of visibility and/or geometry processing in accordance with one or more techniques of this disclosure. As shown in FIG. 5, flowchart 500 includes input assembler 502, geometry processing unit 504, rasterizer 506, visibility recording unit 508, input assembler 510, geometry processing unit 512, rasterizer 514, and fragment shading unit 516. Flowchart 500 also includes memory resources 520 including command buffers 521, index buffers 522, vertex buffers 523, textures 524, constants 525, visibility buffer 526, and color/depth buffers 529.

As further shown in FIG. 5, the visibility recording unit 508 can send a primitive visibility stream 509, which includes per-view visibility information 511, to the visibility buffer 526. Also, the input assembler 510 can retrieve the primitive visibility stream 509 from the visibility buffer 526. The input assembler 510 can then send the per-view visibility information 511 and/or the primitive visibility stream to the geometry processing unit 512. At the geometry processing unit 512, the GPU can avoid the geometry processing of invisible primitives in certain viewpoints. By doing so, aspects of the present disclosure can avoid unnecessary geometry processing or rendering.

FIG. 5 displays that aspects of the present disclosure can utilize existing visibility recording blocks to add extra information or bits in the visibility stream, e.g., to indicate the visibility information of each primitive in each viewpoint. For instance, in the bin-rendering pass, the per-view visibility information can be stored until the GPU hardware replicates primitives for each viewpoint. The per-view visibility information can then be used to only replicate primitives that are visible in certain viewpoints. Therefore, aspects of the present disclosure can reduce unnecessary or unwanted geometry or vertex processing.

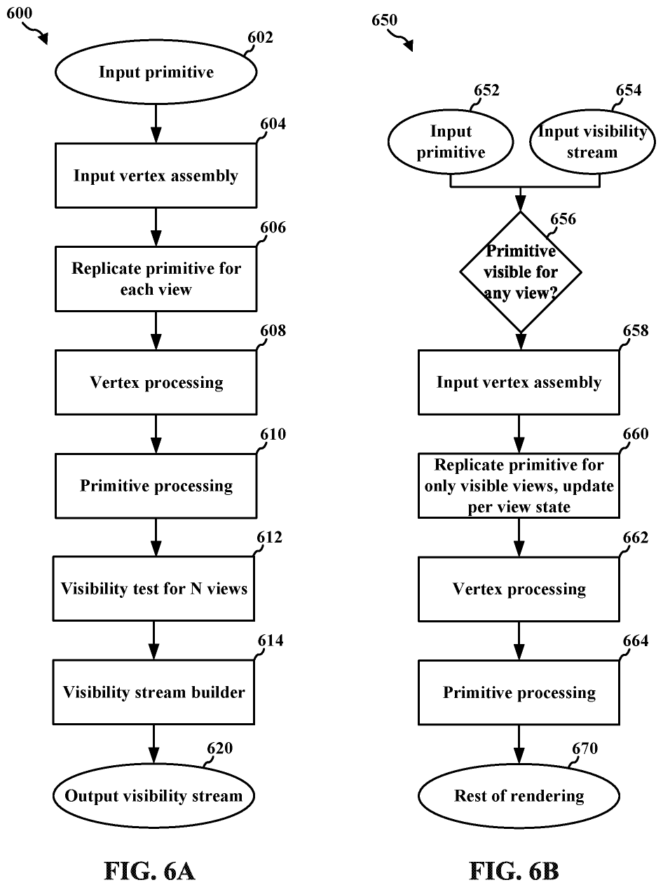

FIGS. 6A and 6B illustrate example flowcharts 600 and 650, respectively. As shown in FIG. 6A, flowchart 600 represents a visibility or bin-visibility process or pass of a GPU according to an aspect the present disclosure. At 602, the GPU can input primitives. At 604, the GPU can input the vertex assembly. For instance, after the GPU inputs a primitive during the visibility pass, the GPU can perform a vertex assembly. At 606, the GPU can replicate the primitives for each view. Next, at 608, the GPU can perform vertex processing. During the vertex processing, the primitives can be processed on a per-view basis. At 610, the GPU can perform primitive processing. At 612, the GPU can perform a visibility test for a certain amount of viewpoints, e.g., N viewpoints. At 614, the GPU can build the visibility stream, e.g., for N viewpoints. At 620, the GPU can output the visibility stream.

As shown in FIG. 6B, flowchart 650 represents a rendering or bin-rendering process or pass of a GPU according to an aspect of the present disclosure. At 652, the GPU can input primitives. At 654, the GPU can input the visibility stream. At 656, the GPU can determine whether a primitive is visible for any viewpoint. At 658, the GPU can input a vertex assembly. Next, at 660, the GPU can replicate or duplicate the primitives that are visible for certain viewpoints, as well as update a per-view or viewpoint state. At 662, the GPU can perform vertex processing. During the vertex processing, the primitives can be processed on a per-view basis. At 664, the GPU can perform primitive processing. At 670, the GPU can perform the rest of the rendering process.

As shown in FIG. 6B, in the rendering pass, aspects of the present disclosure can input primitives and the visibility stream. GPUs herein can then use the per-view visibility stream to skip the geometry processing for invisible primitives in certain viewpoints and/or bins. Accordingly, aspects of the present disclosure can save on vertex processing when a primitive is invisible on a per-view and/or per-bin basis. If a primitive is visible, then the GPU can perform the vertex processing and the primitive processing, as well as the rest of the rendering. As such, aspects of the present disclosure may not discard any primitives because the invisible primitives are skipped. Indeed, rather than discarding invisible primitives that have been unnecessarily processed, aspects of the present disclosure can skip the invisible primitives before the geometry processing is performed. This way, GPUs herein can avoid the unnecessary work of processing the geometry of invisible primitives.

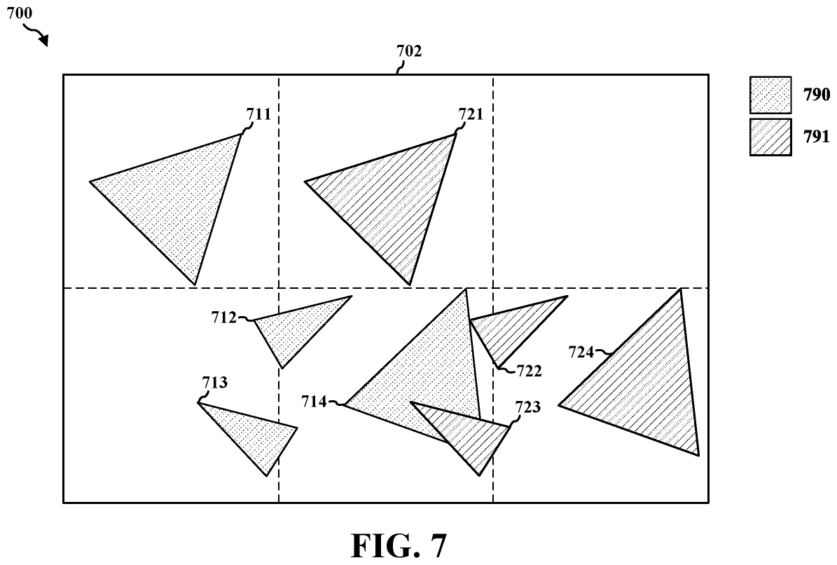

FIG. 7 illustrates an image or surface 700 including area 702 in accordance with one or more techniques of this disclosure. As shown in FIG. 7, image or surface 700 includes primitives 711, 712, 713, and 714 in first viewpoint 790. As further shown in FIG. 7, image or surface 700 includes primitives 721, 722, 723, and 724 in second viewpoint 791. Additionally, as shown in FIG. 7, primitives 711, 712, 713, and 714 and primitives 721, 722, 723, and 724 can be divided into different bins.

FIG. 7 illustrates one example of the aforementioned process for determining a primitive visibility stream including visibility information on a per-view basis. As shown in FIG. 7, aspects of the present disclosure, e.g., GPUs herein, can perform a number of different steps or processes to determine the primitive visibility stream or visibility information on a per-view basis. For instance, GPUs herein can determine a plurality of primitives in a first viewpoint of an image, e.g., primitives 711-714 in first viewpoint 790, a plurality of primitives in at least one additional viewpoint of the image, e.g., primitives 721-724 in second viewpoint 791, or a plurality of primitives in any available viewpoint of the image. GPUs herein can also determine visibility information for each of the plurality of primitives in the first viewpoint, e.g., primitives 711-714 in first viewpoint 790. In some aspects, the visibility information can include information regarding whether the primitive is visible in the first viewpoint. GPUs herein can also determine visibility information for each of the plurality of primitives in the at least one additional viewpoint, e.g., primitives 721-724 in second viewpoint 791. The visibility information can include information regarding whether the primitive is visible in the at least one additional viewpoint. In some aspects, the visibility information for each of the plurality of primitives in the first viewpoint, e.g., primitives 711-714 in first viewpoint 790, and the visibility information for each of the plurality of primitives in the at least one additional viewpoint, e.g., primitives 721-724 in second viewpoint 791, can be determined in a graphics processing pipeline of a GPU.

Additionally, GPUs herein can determine a visibility stream based on the determined visibility information for each of the plurality of primitives in the first viewpoint, e.g., primitives 711-714 in first viewpoint 790. GPUs herein can also adjust the visibility stream to include the determined visibility information for each of the plurality of primitives in the at least one additional viewpoint, e.g., primitives 721-724 in second viewpoint 791. Additionally, GPUs herein can generate the visibility stream based on the determined visibility information for each of the plurality of primitives in the first viewpoint, e.g., primitives 711-714 in first viewpoint 790, and the determined visibility information for each of the plurality of primitives in the at least one additional viewpoint, e.g., primitives 721-724 in second viewpoint 791.

GPUs herein can also identify at least one of the plurality of primitives in the first viewpoint as not visible based on the determined visibility information, e.g., primitive 711 in first viewpoint 790 may be identified as not visible. The GPUs herein can also identify at least one of the plurality of primitives in the at least one additional viewpoint as not visible based on the determined visibility information, e.g., primitive 724 in second viewpoint 791 may be identified as not visible. GPUs herein can also identify one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint, e.g., primitive 712 in first viewpoint 790 and primitive 721 in the second viewpoint 791 may be identified as visible. In some aspects, GPUs herein can mark the one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint, e.g., primitive 712 in first viewpoint 790 and primitive 721 in the second viewpoint 791 may be marked as visible. Additionally, the one or more of the plurality of primitives in the first viewpoint and the plurality of primitives in the at least one additional viewpoint identified as visible can be at least partially visible, e.g., primitive 712 in first viewpoint 790 and primitive 721 in the second viewpoint 791 may be at least partially visible.

Moreover, GPUs herein can determine position information for each of the plurality of primitives in the first viewpoint and for each of the plurality of primitives in the at least one additional viewpoint, e.g., primitives 711-714 in first viewpoint 790 and primitives 721-724 in second viewpoint 791. The position information can include information regarding a location of the primitive, e.g., the location of primitive 712 and primitive 721. In some aspects, the one or more of the plurality of primitives in the first viewpoint and the plurality of primitives in the at least one additional viewpoint can be identified as visible based on the determined position information, e.g., primitive 712 in first viewpoint 790 and primitive 721 in the second viewpoint 791 can be identified as visible based on the determined position information.

GPUs herein can also send the visibility stream, e.g., visibility stream 509 in FIG. 5, to a buffer, e.g., visibility buffer 526 in FIG. 5. GPUs herein can also store the visibility stream, e.g., visibility stream 509, in the buffer, e.g., visibility buffer 526. GPUs herein can also retrieve the visibility stream, e.g., visibility stream 509, when the visibility stream is stored in the buffer, e.g., visibility buffer 526.

GPUs herein can also determine to skip rendering the at least one of the plurality of primitives in the first viewpoint identified as not visible, e.g., at geometry processing unit 512 in FIG. 5. GPUs herein can also determine to skip rendering the at least one of the plurality of primitives in the at least one additional viewpoint identified as not visible, e.g., at geometry processing unit 512. Additionally, GPUs herein can determine to skip processing a geometry of the at least one of the plurality of primitives in the first viewpoint identified as not visible, e.g., at geometry processing unit 512. GPUs herein can also determine to skip processing a geometry of the at least one of the plurality of primitives in the at least one additional viewpoint identified as not visible, e.g., at geometry processing unit 512.

Further, GPUs herein can render the one or more of the plurality of primitives in the first viewpoint and the plurality of primitives in the at least one additional viewpoint identified as visible. GPUs herein can generate graphical content based on the determined visibility information for each of the plurality of primitives in the first viewpoint and based on the determined visibility information for each of the plurality of primitives in the at least one additional viewpoint.

As mentioned herein, on a per-view basis, aspects of the present disclosure can mark primitives as visible for certain views or viewpoints. GPUs herein can then perform geometry processing for that viewpoint, which can reduce or save the GPU workload. For instance, aspects of the present disclosure can reduce the processing or rendering workload in GPUs. For example, aspects of the present disclosure can reduce the workload for processing and rendering by avoiding processing the geometry of invisible primitives in certain viewpoints. In some aspects, a certain percentage of primitives, e.g., 42%, may be visible in a certain bin or area. Additionally, aspects of the present disclosure can experience a geometry processing workload reduction. In some aspects, GPUs herein can experience a significant reduction in the amount of invisible primitives rendered. For example, in some aspects, there can be a significant reduction, e.g., a 22.4% reduction, in geometry processing for certain workloads.

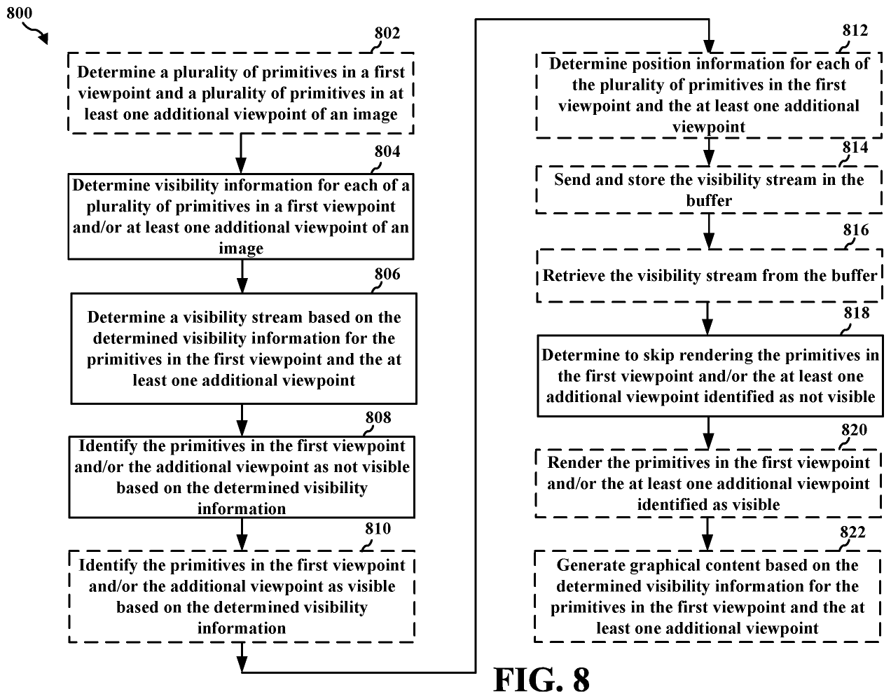

FIG. 8 illustrates an example flowchart 800 of an example method in accordance with one or more techniques of this disclosure. The method may be performed by a GPU or apparatus for graphics processing. At 802, the apparatus can determine a plurality of primitives in a first viewpoint of an image, a plurality of primitives in at least one additional viewpoint of the image, or a plurality of primitives in any available viewpoint of the image, as described in connection with the examples in FIGS. 3A, 3B, 4A, 4B, 5, 6A, 6B, and 7. At 804, the apparatus can determine visibility information for each of the plurality of primitives in the first viewpoint, as described in connection with the examples in FIGS. 3A, 3B, 4A, 4B, 5, 6A, 6B, and 7. In some aspects, the visibility information can include information regarding whether the primitive is visible in the first viewpoint, as described in connection with the examples in FIGS. 3A, 3B, 4A, 4B, 5, 6A, 6B, and 7. The apparatus can also determine visibility information for each of the plurality of primitives in the at least one additional viewpoint or any available viewpoint of the image, as described in connection with the examples in FIGS. 3A, 3B, 4A, 4B, 5, 6A, 6B, and 7. The visibility information can include information regarding whether the primitive is visible in the at least one additional viewpoint, as described in connection with the examples in FIGS. 3A, 3B, 4A, 4B, 5, 6A, 6B, and 7. In some aspects, the visibility information for each of the plurality of primitives in the first viewpoint and the visibility information for each of the plurality of primitives in the at least one additional viewpoint can be determined in a graphics processing pipeline of a GPU, as described in connection with the examples in FIGS. 3A, 3B, 4A, 4B, 5, 6A, 6B, and 7.

At 806, the apparatus can determine a visibility stream based on the determined visibility information for each of the plurality of primitives in the first viewpoint, as described in connection with the examples in FIGS. 3A, 3B, 4A, 4B, 5, 6A, 6B, and 7. The apparatus can also adjust the visibility stream to include the determined visibility information for each of the plurality of primitives in the at least one additional viewpoint, as described in connection with the examples in FIGS. 3A, 3B, 4A, 4B, 5, 6A, 6B, and 7. Additionally, the apparatus can generate the visibility stream based on the determined visibility information for each of the plurality of primitives in the first viewpoint and the determined visibility information for each of the plurality of primitives in the at least one additional viewpoint, as described in connection with the examples in FIGS. 3A, 3B, 4A, 4B, 5, 6A, 6B, and 7.

At 808, the apparatus can identify at least one of the plurality of primitives in the first viewpoint as not visible based on the determined visibility information, as described in connection with the examples in FIGS. 3A, 3B, 4A, 4B, 5, 6A, 6B, and 7. The apparatus can also identify at least one of the plurality of primitives in the at least one additional viewpoint as not visible based on the determined visibility information, as described in connection with the examples in FIGS. 3A, 3B, 4A, 4B, 5, 6A, 6B, and 7. At 810, the apparatus can identify one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint, as described in connection with the examples in FIGS. 3A, 3B, 4A, 4B, 5, 6A, 6B, and 7. In some aspects, the apparatus can mark the one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint, as described in connection with the examples in FIGS. 3A, 3B, 4A, 4B, 5, 6A, 6B, and 7. Additionally, the one or more of the plurality of primitives in the first viewpoint and the plurality of primitives in the at least one additional viewpoint identified as visible can be at least partially visible, as described in connection with the examples in FIGS. 3A, 3B, 4A, 4B, 5, 6A, 6B, and 7.

At 812, the apparatus can determine position information for each of the plurality of primitives in the first viewpoint and for each of the plurality of primitives in the at least one additional viewpoint, as described in connection with the examples in FIGS. 3A, 3B, 4A, 4B, 5, 6A, 6B, and 7. The position information can include information regarding a location of the primitive, as described in connection with the examples in FIGS. 3A, 3B, 4A, 4B, 5, 6A, 6B, and 7. In some aspects, the one or more of the plurality of primitives in the first viewpoint and the plurality of primitives in the at least one additional viewpoint can be identified as visible based on the determined position information, as described in connection with the examples in FIGS. 3A, 3B, 4A, 4B, 5, 6A, 6B, and 7.

At 814, the apparatus can send the visibility stream to a buffer, as described in connection with the examples in FIGS. 3A, 3B, 4A, 4B, 5, 6A, 6B, and 7. The apparatus can also store the visibility stream in the buffer, as described in connection with the examples in FIGS. 3A, 3B, 4A, 4B, 5, 6A, 6B, and 7. At 816, the apparatus can retrieve the visibility stream when the visibility stream is stored in the buffer, as described in connection with the examples in FIGS. 3A, 3B, 4A, 4B, 5, 6A, 6B, and 7.

At 818, the apparatus can determine to skip rendering the at least one of the plurality of primitives in the first viewpoint identified as not visible, as described in connection with the examples in FIGS. 3A, 3B, 4A, 4B, 5, 6A, 6B, and 7. The apparatus can also determine to skip rendering the at least one of the plurality of primitives in the at least one additional viewpoint identified as not visible, as described in connection with the examples in FIGS. 3A, 3B, 4A, 4B, 5, 6A, 6B, and 7. Additionally, the apparatus can determine to skip processing a geometry of the at least one of the plurality of primitives in the first viewpoint identified as not visible, as described in connection with the examples in FIGS. 3A, 3B, 4A, 4B, 5, 6A, 6B, and 7. The apparatus can also determine to skip processing a geometry of the at least one of the plurality of primitives in the at least one additional viewpoint identified as not visible, as described in connection with the examples in FIGS. 3A, 3B, 4A, 4B, 5, 6A, 6B, and 7.

At 820, the apparatus can render the one or more of the plurality of primitives in the first viewpoint and the plurality of primitives in the at least one additional viewpoint identified as visible, as described in connection with the examples in FIGS. 3A, 3B, 4A, 4B, 5, 6A, 6B, and 7. At 822, the apparatus can generate graphical content based on the determined visibility information for each of the plurality of primitives in the first viewpoint and based on the determined visibility information for each of the plurality of primitives in the at least one additional viewpoint, as described in connection with the examples in FIGS. 3A, 3B, 4A, 4B, 5, 6A, 6B, and 7.

In one configuration, a method or apparatus for graphics processing is provided. The apparatus may be a GPU or some other processor that can perform graphics processing. In one aspect, the apparatus may be the processing unit 120 within the device 104, or may be some other hardware within device 104 or another device. The apparatus may include means for determining visibility information for each of a plurality of primitives in a first viewpoint of an image or any available viewpoint of the image. The apparatus may also include means for determining a visibility stream based on the determined visibility information for each of the plurality of primitives in the first viewpoint. The apparatus may also include means for identifying at least one of the plurality of primitives in the first viewpoint as not visible based on the determined visibility information. Additionally, the apparatus may include means for determining to skip rendering the at least one of the plurality of primitives in the first viewpoint identified as not visible. The apparatus may also include means for determining visibility information for each of a plurality of primitives in at least one additional viewpoint of the image or any of the available viewpoints of the image. The apparatus may also include means for adjusting the visibility stream to include the determined visibility information for each of the plurality of primitives in the at least one additional viewpoint. The apparatus may also include means for identifying at least one of the plurality of primitives in the at least one additional viewpoint as not visible based on the determined visibility information. The apparatus may also include means for determining to skip rendering the at least one of the plurality of primitives in the at least one additional viewpoint identified as not visible. The apparatus may also include means for sending the visibility stream to a buffer. The apparatus may also include means for storing the visibility stream in the buffer. The apparatus may also include means for retrieving the visibility stream when the visibility stream is stored in the buffer. The apparatus may also include means for identifying one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint. The apparatus may also include means for marking the one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint. The apparatus may also include means for determining position information for each of the plurality of primitives in the first viewpoint and for each of the plurality of primitives in the at least one additional viewpoint. The apparatus may also include means for rendering the one or more of the plurality of primitives in the first viewpoint and the plurality of primitives in the at least one additional viewpoint identified as visible. The apparatus may also include means for determining to skip processing a geometry of the at least one of the plurality of primitives in the first viewpoint identified as not visible. The apparatus may also include means for determining to skip processing a geometry of the at least one of the plurality of primitives in the at least one additional viewpoint identified as not visible. The apparatus may also include means for generating the visibility stream based on the determined visibility information for each of the plurality of primitives in the first viewpoint and the determined visibility information for each of the plurality of primitives in the at least one additional viewpoint. The apparatus may also include means for determining the plurality of primitives in the first viewpoint and the plurality of primitives in the at least one additional viewpoint. The apparatus may also include means for generating graphical content based on the determined visibility information for each of the plurality of primitives in the first viewpoint and based on the determined visibility information for each of the plurality of primitives in the at least one additional viewpoint.

The subject matter described herein can be implemented to realize one or more benefits or advantages. For instance, the described graphics processing techniques can be accomplished at a low cost compared to other graphics processing techniques. Moreover, the graphics processing techniques herein can improve or speed up the data processing or execution of GPUs. Further, the graphics processing techniques herein can improve the resource or data utilization and/or resource efficiency in a GPU. Also, aspects of the present disclosure can mitigate or reduce the workload in a GPU, e.g., by avoiding processing the geometry of invisible primitives in certain viewpoints.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices,. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method for graphics processing, comprising:
determining visibility information for each of a plurality of primitives in a first viewpoint of an image, wherein the visibility information includes information regarding whether the primitive is visible in the first viewpoint;
determining a visibility stream based on the determined visibility information for each of the plurality of primitives in the first viewpoint;
identifying at least one of the plurality of primitives in the first viewpoint as not visible based on the determined visibility information; and
determining to skip rendering the at least one of the plurality of primitives in the first viewpoint identified as not visible.

2. The method of claim 1, further comprising:
determining visibility information for each of a plurality of primitives in at least one additional viewpoint of the image, wherein the visibility information includes information regarding whether the primitive is visible in the at least one additional viewpoint.

3. The method of claim 2, further comprising:
adjusting the visibility stream to include the determined visibility information for each of the plurality of primitives in the at least one additional viewpoint.

4. The method of claim 3, further comprising:
identifying at least one of the plurality of primitives in the at least one additional viewpoint as not visible based on the determined visibility information; and
determining to skip rendering the at least one of the plurality of primitives in the at least one additional viewpoint identified as not visible.

5. The method of claim 3, further comprising:
sending the visibility stream to a buffer; and
storing the visibility stream in the buffer.

6. The method of claim 5, further comprising:
retrieving the visibility stream when the visibility stream is stored in the buffer.

7. The method of claim 2, further comprising:
identifying one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint.

8. The method of claim 7, wherein identifying one or more of the plurality of primitives in the first viewpoint and the plurality of primitives in the at least one additional viewpoint as visible comprises:
marking the one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint.

9. The method of claim 7, further comprising:
determining position information for each of the plurality of primitives in the first viewpoint and for each of the plurality of primitives in the at least one additional viewpoint, wherein the position information includes information regarding a location of the primitive;
wherein the one or more of the plurality of primitives in the first viewpoint and the plurality of primitives in the at least one additional viewpoint are identified as visible based on the determined position information.

10. The method of claim 7, further comprising:
rendering the one or more of the plurality of primitives in the first viewpoint and the plurality of primitives in the at least one additional viewpoint identified as visible.

11. The method of claim 7, wherein the one or more of the plurality of primitives in the first viewpoint and the plurality of primitives in the at least one additional viewpoint identified as visible are at least partially visible.

12. The method of claim 4, wherein determining to skip rendering the at least one of the plurality of primitives in the first viewpoint identified as not visible comprises:
determining to skip processing a geometry of the at least one of the plurality of primitives in the first viewpoint identified as not visible; and
wherein determining to skip rendering the at least one of the plurality of primitives in the at least one additional viewpoint identified as not visible comprises:
determining to skip processing a geometry of the at least one of the plurality of primitives in the at least one additional viewpoint identified as not visible.

13. The method of claim 3, further comprising:
generating the visibility stream based on the determined visibility information for each of the plurality of primitives in the first viewpoint and the determined visibility information for each of the plurality of primitives in the at least one additional viewpoint.

14. The method of claim 2, further comprising:
determining the plurality of primitives in the first viewpoint and the plurality of primitives in the at least one additional viewpoint.

15. The method of claim 2, further comprising:
generating graphical content based on the determined visibility information for each of the plurality of primitives in the first viewpoint and based on the determined visibility information for each of the plurality of primitives in the at least one additional viewpoint.

16. The method of claim 2, wherein the visibility information for each of the plurality of primitives in the first viewpoint and the visibility information for each of the plurality of primitives in the at least one additional viewpoint is determined in a graphics processing pipeline of a graphics processing unit (GPU).

17. An apparatus for graphics processing, comprising:
a memory; and
at least one processor coupled to the memory and configured to:
determine visibility information for each of a plurality of primitives in a first viewpoint of an image, wherein the visibility information includes information regarding whether the primitive is visible in the first viewpoint;
determine a visibility stream based on the determined visibility information for each of the plurality of primitives in the first viewpoint;
identify at least one of the plurality of primitives in the first viewpoint as not visible based on the determined visibility information; and
determine to skip rendering the at least one of the plurality of primitives in the first viewpoint identified as not visible.

18. The apparatus of claim 17, wherein the at least one processor is further configured to:
determine visibility information for each of a plurality of primitives in at least one additional viewpoint of the image, wherein the visibility information includes information regarding whether the primitive is visible in the at least one additional viewpoint.

19. The apparatus of claim 18, wherein the at least one processor is further configured to:
adjust the visibility stream to include the determined visibility information for each of the plurality of primitives in the at least one additional viewpoint.

20. The apparatus of claim 19, wherein the at least one processor is further configured to:
identify at least one of the plurality of primitives in the at least one additional viewpoint as not visible based on the determined visibility information; and
determine to skip rendering the at least one of the plurality of primitives in the at least one additional viewpoint identified as not visible.

21. The apparatus of claim 19, wherein the at least one processor is further configured to:
send the visibility stream to a buffer; and
store the visibility stream in the buffer.

22. The apparatus of claim 21, wherein the at least one processor is further configured to:
retrieve the visibility stream when the visibility stream is stored in the buffer.

23. The apparatus of claim 18, wherein the at least one processor is further configured to:
identify one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint.

24. The apparatus of claim 23, wherein to identify one or more of the plurality of primitives in the first viewpoint and the plurality of primitives in the at least one additional viewpoint as visible includes the at least one processor further configured to:
mark the one or more of the plurality of primitives in the first viewpoint and the plurality of primitives in the at least one additional viewpoint as visible based on the determined visibility information for each of the plurality of primitives in the first viewpoint and the determined visibility information for each of the plurality of primitives in the at least one additional viewpoint.

25. The apparatus of claim 23, wherein the at least one processor is further configured to:
determine position information for each of the plurality of primitives in the first viewpoint and for each of the plurality of primitives in the at least one additional viewpoint, wherein the position information includes information regarding a location of the primitive;
wherein the one or more of the plurality of primitives in the first viewpoint and the plurality of primitives in the at least one additional viewpoint are identified as visible based on the determined position information.

26. The apparatus of claim 20, wherein to determine to skip rendering the at least one of the plurality of primitives in the first viewpoint identified as not visible includes the at least one processor further configured to:
determine to skip processing a geometry of the at least one of the plurality of primitives in the first viewpoint identified as not visible; and
wherein to determine to skip rendering the at least one of the plurality of primitives in the at least one additional viewpoint identified as not visible includes the at least one processor further configured to:
determine to skip processing a geometry of the at least one of the plurality of primitives in the at least one additional viewpoint identified as not visible.

27. The apparatus of claim 19, wherein the at least one processor is further configured to:
generate the visibility stream based on the determined visibility information for each of the plurality of primitives in the first viewpoint and the determined visibility information for each of the plurality of primitives in the at least one additional viewpoint.

28. The apparatus of claim 18, wherein the at least one processor is further configured to:
determine the plurality of primitives in the first viewpoint and the plurality of primitives in the at least one additional viewpoint; and
generate graphical content based on the determined visibility information for each of the plurality of primitives in the first viewpoint and based on the determined visibility information for each of the plurality of primitives in the at least one additional viewpoint.

29. An apparatus for graphics processing, comprising:
means for determining visibility information for each of a plurality of primitives in a first viewpoint of an image, wherein the visibility information includes information regarding whether the primitive is visible in the first viewpoint;
means for determining a visibility stream based on the determined visibility information for each of the plurality of primitives in the first viewpoint;
means for identifying at least one of the plurality of primitives in the first viewpoint as not visible based on the determined visibility information; and
means for determining to skip rendering the at least one of the plurality of primitives in the first viewpoint identified as not visible.

30. A computer-readable medium storing computer executable code for graphics processing, comprising code to:
determine visibility information for each of a plurality of primitives in a first viewpoint of an image, wherein the visibility information includes information regarding whether the primitive is visible in the first viewpoint;
determine a visibility stream based on the determined visibility information for each of the plurality of primitives in the first viewpoint;
identify at least one of the plurality of primitives in the first viewpoint as not visible based on the determined visibility information; and
determine to skip rendering the at least one of the plurality of primitives in the first viewpoint identified as not visible.
